(19) United States
(12) Patent Application Publication
(10) Pub. No.: US 2025/0222714 A1
(43) Pub. Date: Jul. 10, 2025

(54) CARD SKIN OVERLAY SYSTEM AND METHOD

(71) Applicant: Manuela Alejandra Da Silva Rodrigues, Ft. Lauderdale, FL (US)

(72) Inventor: Manuela Alejandra Da Silva Rodrigues, Ft. Lauderdale, FL (US)

(21) Appl. No.: 18/914,852

(22) Filed: Oct. 14, 2024

Related U.S. Application Data
(60) Provisional application No. 63/578,909, filed on Aug. 25, 2023.

(51) Int. Cl. B42D 25/47; B42D 25/20

(52) U.S. Cl. CPC B42D 25/47; B42D 25/20

(57) ABSTRACT

A credit card skin overlay and/or card skin overlay is provided. The credit card skin overlay and/or card skin overlay comprises a cast vinyl material, an adhesive layer, and ornamental elements. The cast vinyl material may have a thickness greater than conventional credit card skins. The adhesive layer may be removable. The ornamental elements may comprise simulated rhinestones. The second side may have a textured surface. The overlay may further comprise decorative text. A method of manufacturing the credit card skin overlay and/or card skin overlay may include preparing a cast vinyl material. The method may involve applying an adhesive layer to a first side of the cast vinyl material. The method may include attaching ornamental elements to a second side of the cast vinyl material. The cast vinyl material may have a thickness similar to automotive vinyl wraps. The method may further comprise creating a textured surface on the second side. The method may also include incorporating decorative text into the overlay.

### FIELD OF THE INVENTION

The present disclosure relates generally to credit card accessories and more particularly to customizable credit card skins. More specifically, the present disclosure relates to one or more of the following CPC classifications: B42D25/47 Associating two or more layers using chemicals or adhesives using adhesives; B42D25/47-Associating two or more layers using chemicals or adhesives using adhesives; B42D25/00-Information-bearing cards or sheet-like structures characterized by identification or security features; Manufacture thereof; B42D25/40-Manufacture; B42D25/45-Associating two or more layers; B42D25/465-Associating two or more layers using chemicals or adhesives; G06K19/00 Record carriers for use with machines and with at least a part designed to carry digital markings; B42D25/00 Information-bearing cards or sheet-like structures characterized by identification or security features; Manufacture thereof; G06K19/005 Record carriers for use with machines and with at least a part designed to carry digital markings the record carrier comprising an arrangement to facilitate insertion into a holding device, e.g. an arrangement that makes the record carrier fit into an etui or a casing.

### BACKGROUND

Credit cards are widely used financial instruments. However, standard credit cards typically have a uniform appearance. Users may desire to personalize or enhance the aesthetic appeal of their credit cards. Existing credit card covers or skins may be limited in their durability, design options, or ease of application and removal. There may be a need for improved credit card customization solutions that offer enhanced aesthetics and functionality.

### SUMMARY

The following is a brief overview of the presently disclosed subject matter and should not be construed as a comprehensive description of all embodiments or all aspects of the disclosure.

A card skin overlay and/or credit card skin overlay may comprise a cast vinyl material. An adhesive layer may be on a first side of the cast vinyl material. Ornamental elements may be on a second side of the cast vinyl material. A method of manufacturing a credit card skin overlay may comprise preparing a cast vinyl material. The method may involve applying an adhesive layer to a first side of the cast vinyl material. The method may include attaching ornamental elements to a second side of the cast vinyl material.

A method of customizing a credit card may comprise selecting a credit card skin overlay and/or card skin overlay. The method may involve aligning the overlay with a credit card. The method may include pressing the overlay onto the credit card to adhere it to the card surface.

A system for designing credit card skin overlay and/or card skin overlays may comprise a design software interface. The system may include a canvas area for creating overlay layouts. The system may have tool options for manipulating design elements.

A credit card skin overlay and/or card skin overlay kit may comprise multiple overlay designs. The kit may include application instructions. The kit may contain a removal tool.

The above summary is not intended to describe each illustrated embodiment or every implementation of the present disclosure. These together with additional objects, features and advantages of the systems and methods of fraud identification will be readily apparent to those of ordinary skill in the art upon reading the following detailed description of the presently preferred, but nonetheless illustrative, embodiments when taken in conjunction with the accompanying drawings.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

Additional aspects of the disclosure will be set forth in part in the description which follows, and in part will be obvious from the description, or can be learned by practice of the disclosure. The advantages of the disclosure will be realized and attained by means of the elements and combinations particularly pointed out in the appended claims. It is to be understood that both the foregoing general description and the following detailed description are and explanatory only and are not restrictive of the disclosure, as claimed.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the Applicants. The Applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 shows a credit card skin overlay and/or card skin overlay with textured and decorative elements.

FIG. 2 illustrates a design software interface for creating credit card skin designs.

FIG. 3 shows a credit card skin overlay and/or card skin overlay with textured and decorative elements.

FIG. 4 shows a credit card skin overlay and/or card skin overlay with textured and decorative elements.

FIG. 5 shows a credit card skin overlay and/or card skin overlay with textured and decorative elements.

FIG. 6 shows a credit card skin overlay and/or card skin overlay with textured and

decorative elements.

FIG. 7 shows a credit card skin overlay and/or card skin overlay with textured and decorative elements.

FIG. 8 shows a credit card skin overlay and/or card skin overlay with textured and decorative elements.

FIG. 9 shows a credit card skin overlay and/or card skin overlay with textured and decorative elements.

FIG. 10 shows a credit card skin overlay and/or card skin overlay with textured and decorative elements.

FIG. 11 shows a credit card skin overlay and/or card skin overlay with textured and

decorative elements.

FIG. 12 shows a credit card skin overlay and/or card skin overlay with textured and decorative elements.

FIG. 13 shows a credit card skin overlay and/or card skin overlay with textured and decorative elements.

FIG. 14 shows a credit card skin overlay and/or card skin overlay with textured and decorative elements.

FIG. 15 shows a credit card skin overlay and/or card skin overlay with textured and decorative elements.

FIG. 16 shows a credit card skin overlay and/or card skin overlay with textured and decorative elements.

FIG. 17 shows a credit card skin overlay and/or card skin overlay with textured and

decorative elements.

FIG. 18 shows a credit card skin overlay and/or card skin overlay with textured and decorative elements.

FIG. 19 shows a printing device capable of producing elements of a credit card skin overlay and/or card skin overlay with textured and decorative elements.

### DETAILED DESCRIPTION

The present disclosure includes many aspects and features. Moreover, while many aspects and features relate to, and are described in embodiments of the present disclosure are not limited to use only in this context. The present disclosure can be understood more readily by reference to the following detailed description of the disclosure and the examples included therein.

Before the present articles, systems, apparatuses, and/or methods are disclosed and described, it is to be understood that they are not limited to specific methods unless otherwise specified, or to particular materials unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present disclosure, example methods and materials are now described.

### A. Definitions

It is also to be understood that the terminology used herein is for the purpose of describing particular aspects only and is not intended to be limiting. As used in the specification and in the claims, the term “comprising” can include the aspects “consisting of” and “consisting essentially of.” Unless defined otherwise, all technical and scientific terms used herein have the same meaning as commonly understood by one of ordinary skill in the art to which this disclosure belongs. In this specification and in the claims which follow, reference will be made to a number of terms which shall be defined herein.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

The terms “first,” “second,” “first part,” “second part,” and the like, where used herein, do not denote any order, quantity, or importance, and are used to distinguish one element from another, unless specifically stated otherwise.

As used herein, the terms “optional” or “optionally” means that the subsequently described event or circumstance can or cannot occur, and that the description includes instances where said event or circumstance occurs and instances where it does not. For example, the phrase “optionally affixed to the surface” means that it can or cannot be fixed to a surface.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

It is understood that the apparatuses and systems disclosed herein have certain functions. Disclosed herein are certain structural requirements for performing the disclosed functions, and it is understood that there are a variety of structures that can perform the same function that are related to the disclosed structures, and that these structures will typically achieve the same result.

Reference will now be made in detail to embodiments of the present disclosure, examples of which are illustrated in the accompanying drawings. Wherever possible, the same reference numbers will be used throughout the drawings to refer to the same or like parts.

A credit card skin overlay and/or card skin overlay may be provided. The overlay may comprise a cast vinyl material. The cast vinyl material may have a thickness greater than conventional credit card skins. The thickness may be similar to that used in automotive vinyl wraps. The overlay may include a removable adhesive backing. The adhesive may allow the overlay to be securely attached to a credit card. The adhesive may also allow for removal of the overlay without leaving residue on the card.

The overlay may feature ornamental elements. These elements may include simulated rhinestones or other decorative objects. The overlay may have textured surfaces. Various designs and colors may be incorporated into the overlay. The overlay may be manufactured through a process involving preparation of the cast vinyl material. An adhesive layer may be applied to one side of the vinyl. Decorative elements may be embedded or attached to the opposite side.

A user may select an overlay based on their aesthetic preferences. The user may align the overlay with their credit card. The overlay may be pressed into place, with the adhesive securing it to the card surface. The overlay may transform the appearance of a standard credit card. The card may transition from a plain plastic surface to a personalized object. The tactile feel of the card may change from smooth to textured.

In one or more embodiments, the texture of the surface and the aluminized appearance is what gives the card overlay a unique bling appearance. The bling effect also relates to the reflective and shiny look of the card overlay. This effect may be used in conjunction with any particular cards including but not limited to credit cards, debit cards, charge cards, business cards, other cards, flyers, and other products. The designs and effects of the card skin overlay

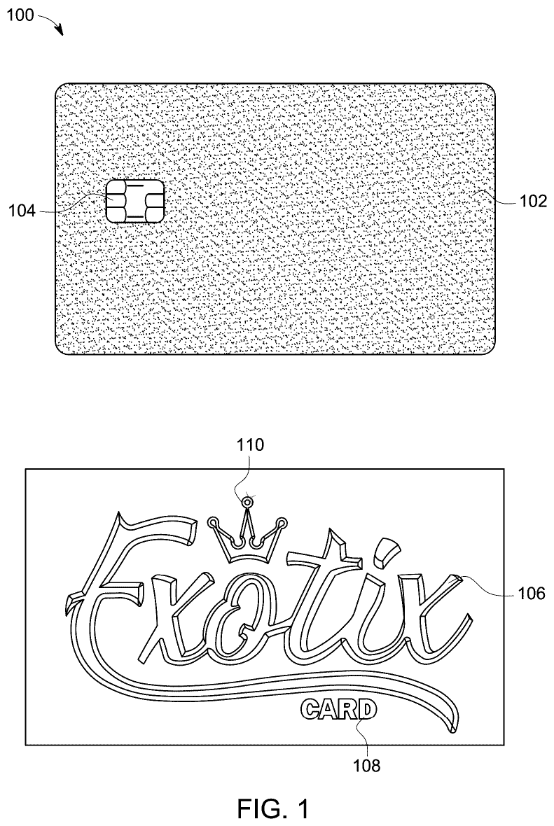

Regarding FIG. 1, it shows an example card skin overlay 100. The overlay 100 may have a textured surface 102 that appears glittery. A small metal chip 104 may be included on one side of the overlay. Decorative text 106 reading “Exotix” may be incorporated in a script font. Additional text 108 reading “CARD” may be included in block letters. A decorative crown element 110 may be positioned above the text.

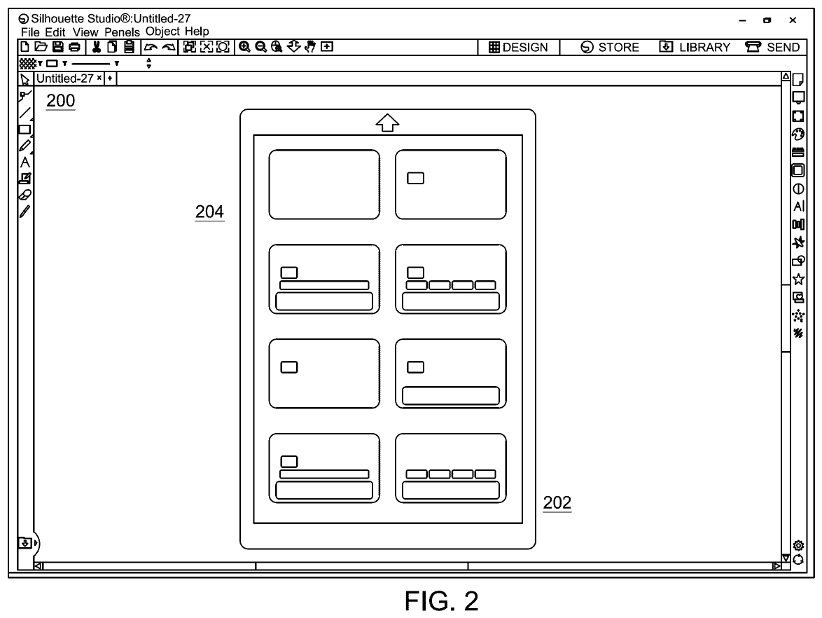

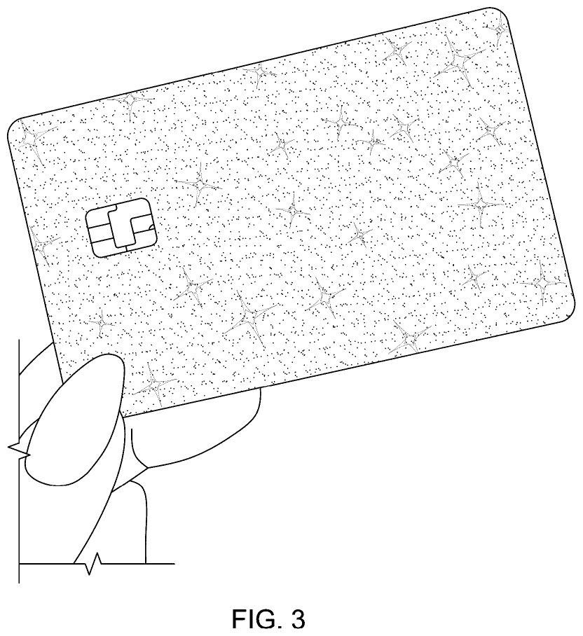

Regarding FIG. 2, it illustrates a design software interface 200 that may be used to create overlay designs. The interface 200 may include a canvas area 202 for designing overlay layouts. Tool options 204 may be provided for manipulating design elements. Multiple design files 206 (not shown) may be open simultaneously.

The credit card skin overlay and/or card skin overlay 100 may provide users with a durable and aesthetically pleasing option for customizing their credit cards. The use of automotive-grade materials and striking designs may differentiate the overlay from existing products.

FIG. 3 may show a hand holding a credit card skin overlay and/or card skin overlay with a glittery, textured surface. The overlay may have a chip cutout on the left side to accommodate the card's chip. The background appears to consist of green foliage, suggesting an outdoor setting.

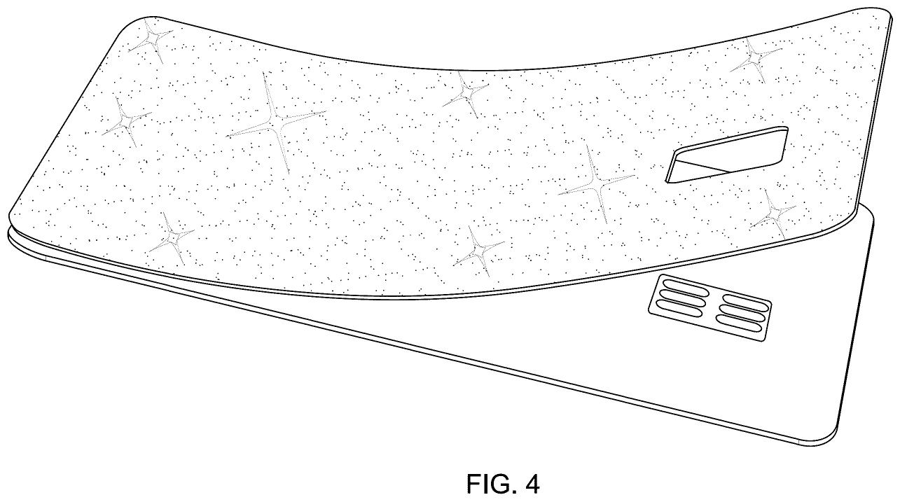

FIG. 4 may depict a credit card skin overlay and/or card skin overlay in a curved or partially peeled back position. The top surface of the overlay may have a glossy pink color with a glittery texture. A rectangular cutout may be visible near one end, likely to allow visibility of card information. The underside of the overlay may be white with some embossed details.

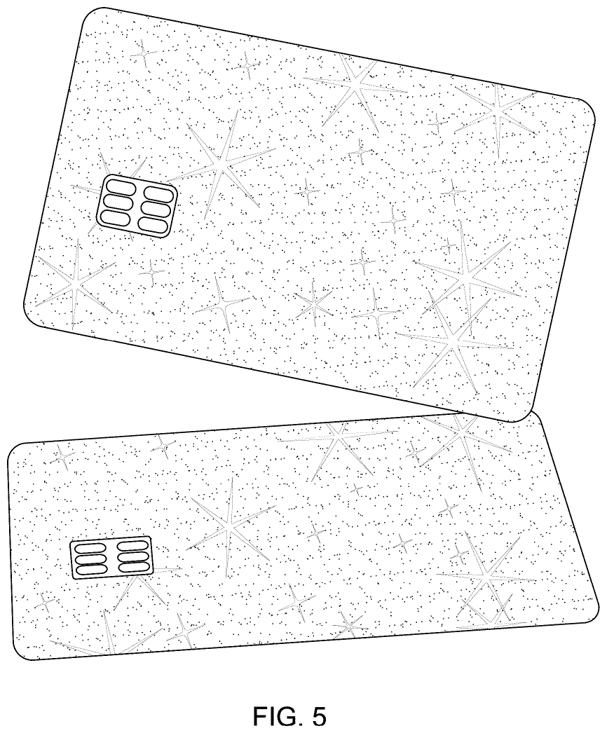

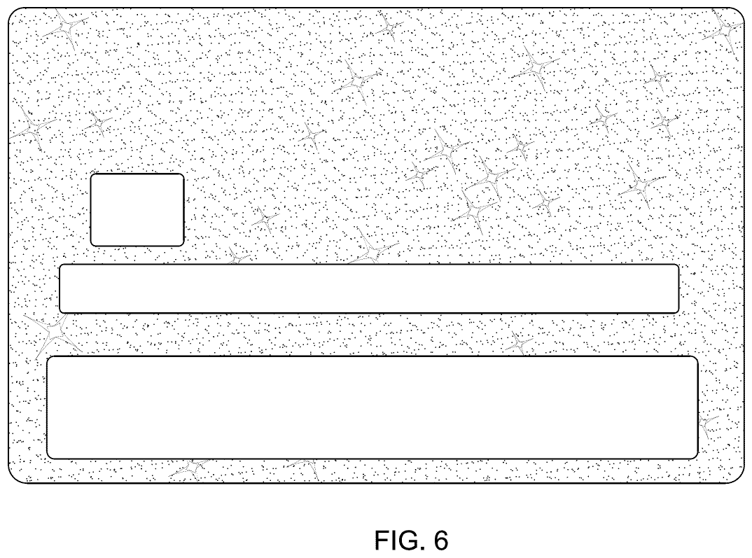

FIG. 5 may illustrate two credit card skin overlay and/or card skin overlays with a black base color and a sparkly or star-like pattern across the surface. One overlay may be positioned horizontally while the other overlaps it diagonally. The overlays may have cutouts or transparent areas to accommodate card chips and magnetic stripes.

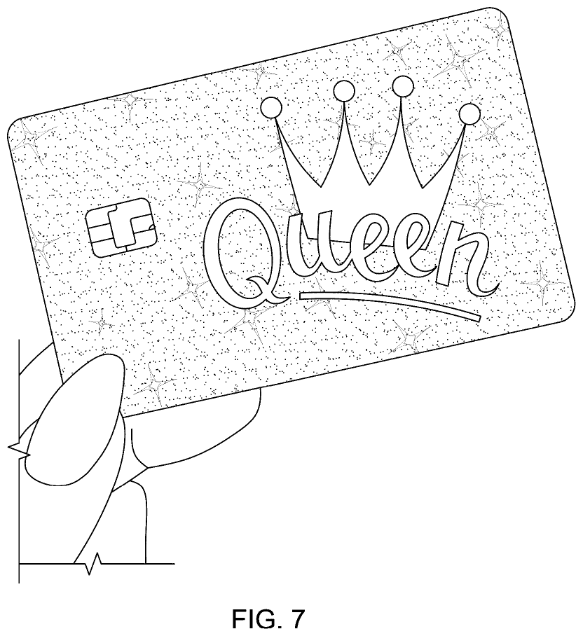

FIG. 6 may show a credit card skin overlay and/or card skin overlay with a glittery texture. The overlay may have cutout areas, including a small square in the upper left corner for the card chip and horizontal rectangular areas below, possibly for the card number or magnetic stripe.

FIG. 7 may depict a credit card skin overlay and/or card skin overlay with a silver glittery background. The overlay may have decorative text reading “Queen” in the center with a pink crown design above it. A cutout area for the card chip may be visible on the left side.

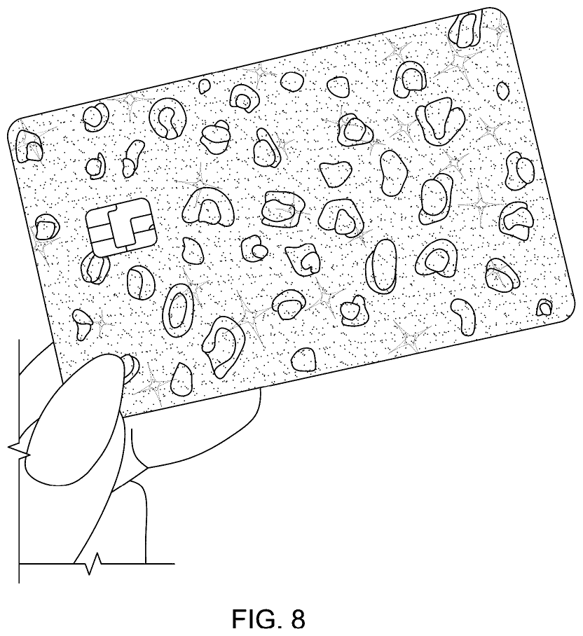

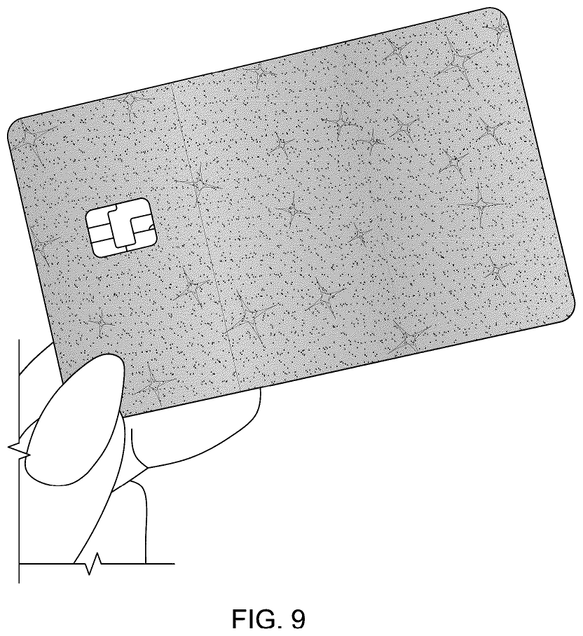

FIG. 8 may show a hand holding a credit card skin overlay and/or card skin overlay with a pink leopard print design. The overlay may have a glittery, textured surface. A rectangular chip cutout may be visible on the left side of the overlay to accommodate the card's chip. The background may consist of blurred green foliage, suggesting an outdoor setting.

FIG. 9 may depict a hand holding a credit card skin overlay and/or card skin overlay with a rainbow gradient design. The overlay may feature a glittery texture spanning colors from pink to blue, green and yellow. A small gold chip cutout may be visible in the upper left corner. The background may show blurred green leaves.

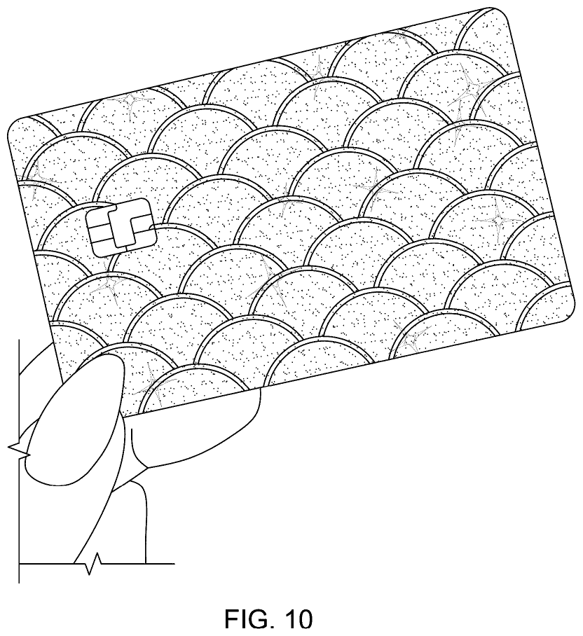

FIG. 10 may illustrate a hand holding a credit card skin overlay and/or card skin overlay with an iridescent, fish scale-like pattern. The overlay may have shimmering colors including pink, purple and blue. The shimmering may have a bling effect. A rectangular chip cutout may be visible on the left side. The background may consist of green foliage.

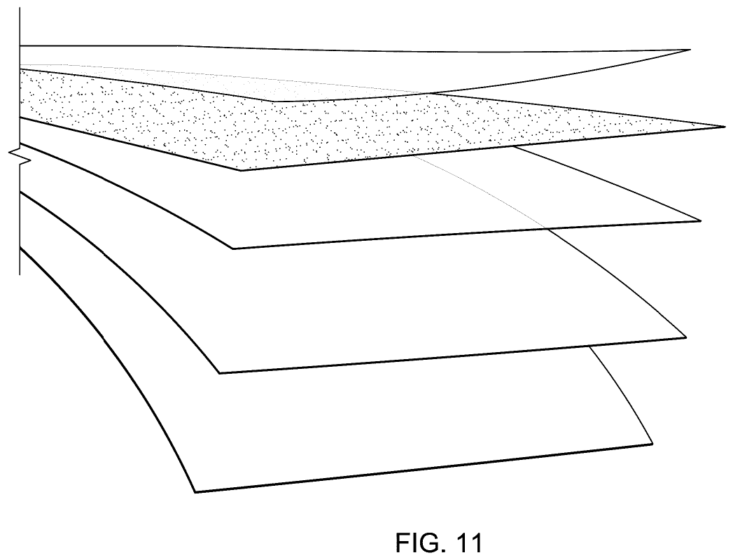

FIG. 11 may show a diagram of the multi-layer structure of the credit card skin overlay and/or card skin overlay, including:
1. Wear-resistant film (top layer)
2. Tiny diamond layer
3. Bottom layer
4. Quality adhesive
5. Release film (bottom layer)

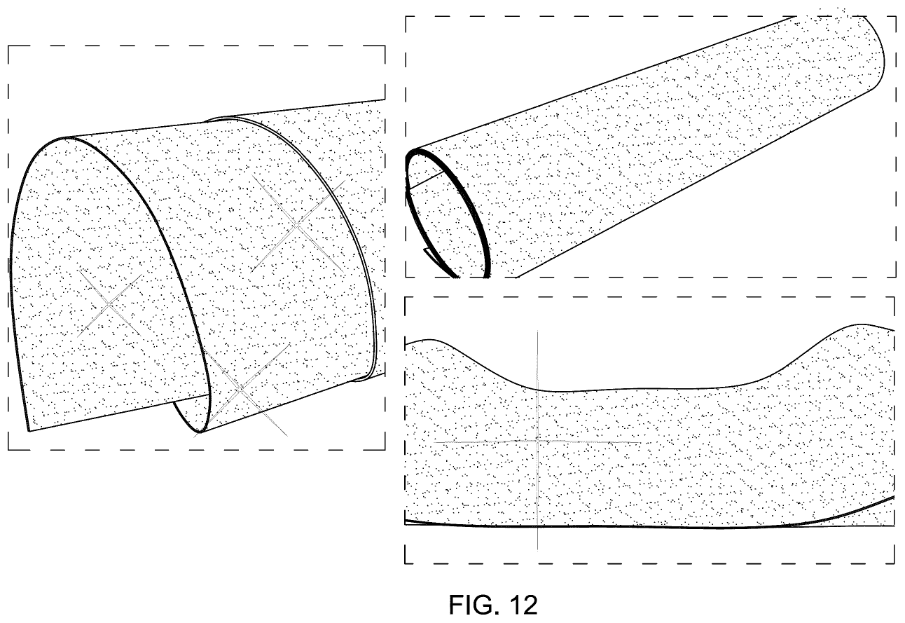

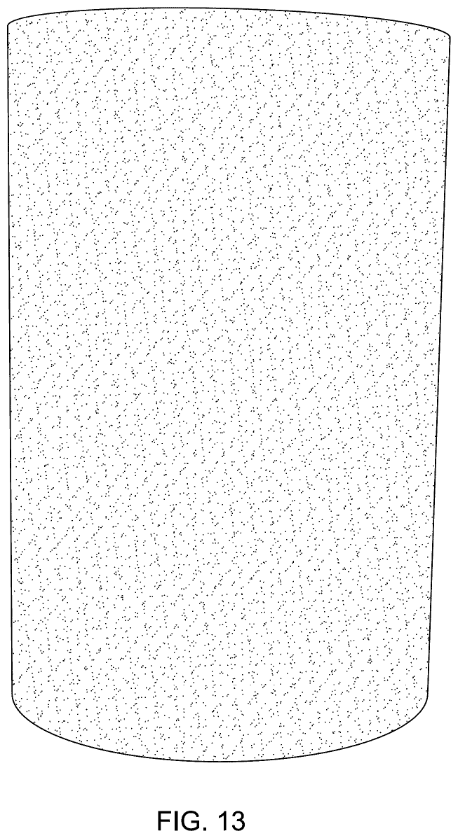

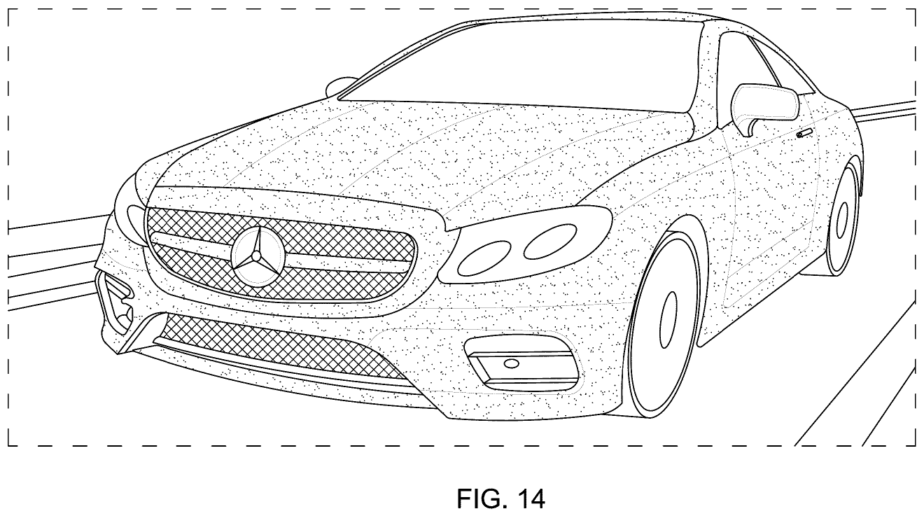

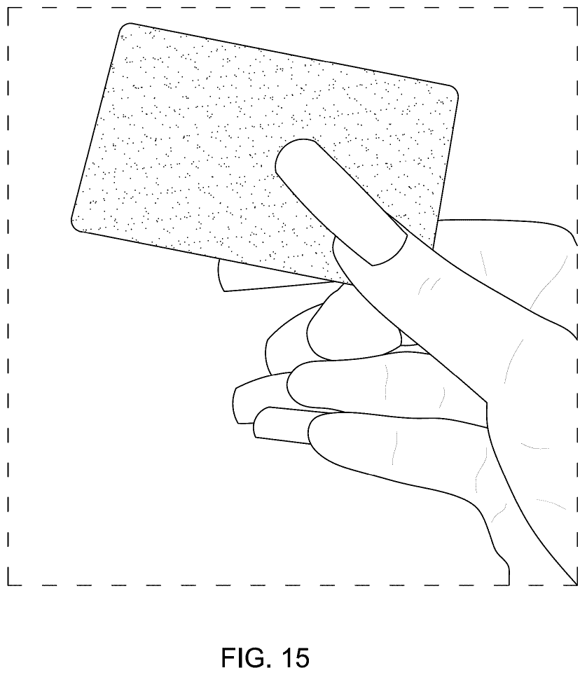

FIG. 12 may depict three views of the glittery material used for the overlay: A partially rolled sheet draped over a dark surface; a cylindrical roll; a wavy sheet laid flat. FIG. 13 may show a large cylindrical roll of the silver glittery material standing upright on a reflective black surface. FIG. 14 may illustrate a vehicle covered in reflective vinyl material, demonstrating the sparkly effect when applied to a vehicle surface. The credit card skin overlay and/or card skin overlay may utilize similar material.

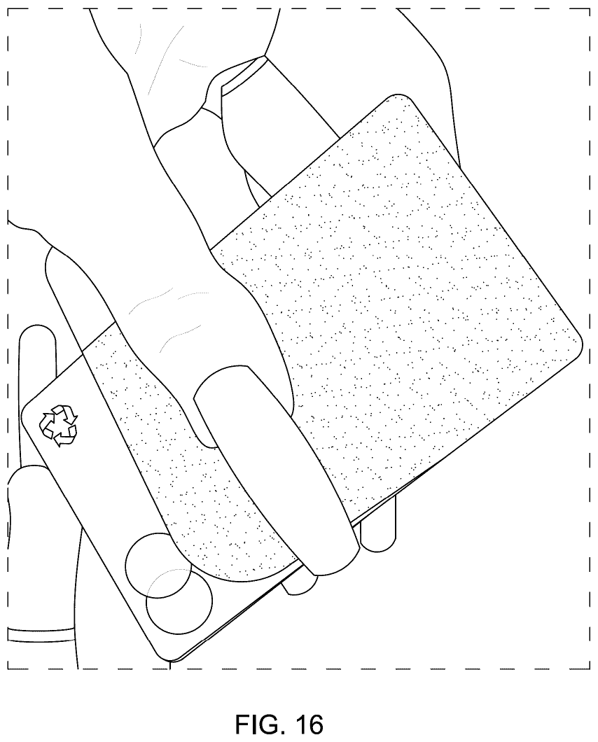

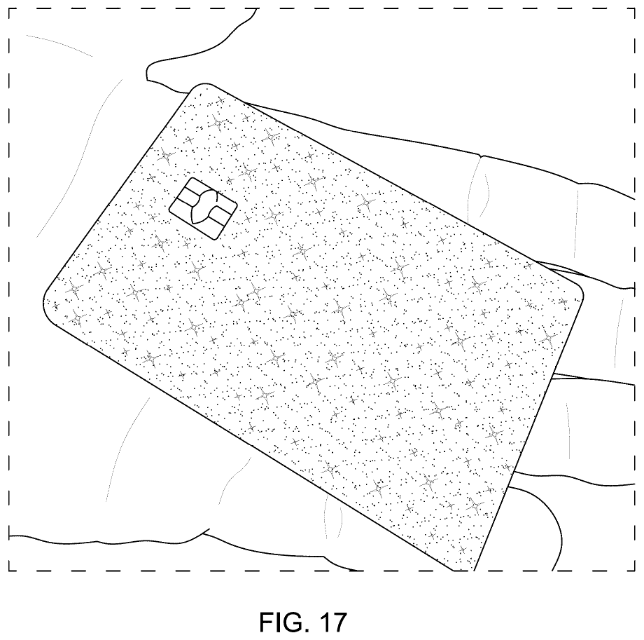

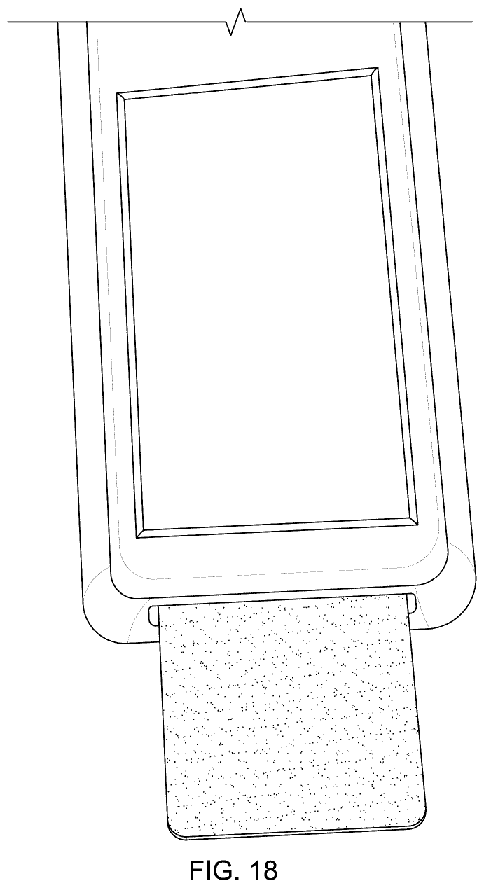

FIG. 15 may show a hand holding a credit card skin overlay and/or card skin overlay with textured and decorative elements in accordance with an embodiment of the invention. FIG. 16 may depict a close-up view of a person holding two objects. FIG. 16 shows a credit card skin overlay and/or card skin overlay with textured and decorative elements in accordance with an embodiment of the invention. FIG. 17 may illustrate a hand holding a sparkling card. The card has a chip embedded in it, similar to a credit card. FIG. 17 shows a credit card skin overlay and/or card skin overlay with textured and decorative elements in accordance with an embodiment of the invention.

FIG. 18 may show a rectangular device with a screen, likely a handheld electronic device such as a smartphone. Attached to the bottom of the device is a rectangular, textured component with a sparkling or reflective appearance. FIG. 18 shows a credit card skin overlay and/or card skin overlay with textured and decorative elements in accordance with an embodiment of the invention.

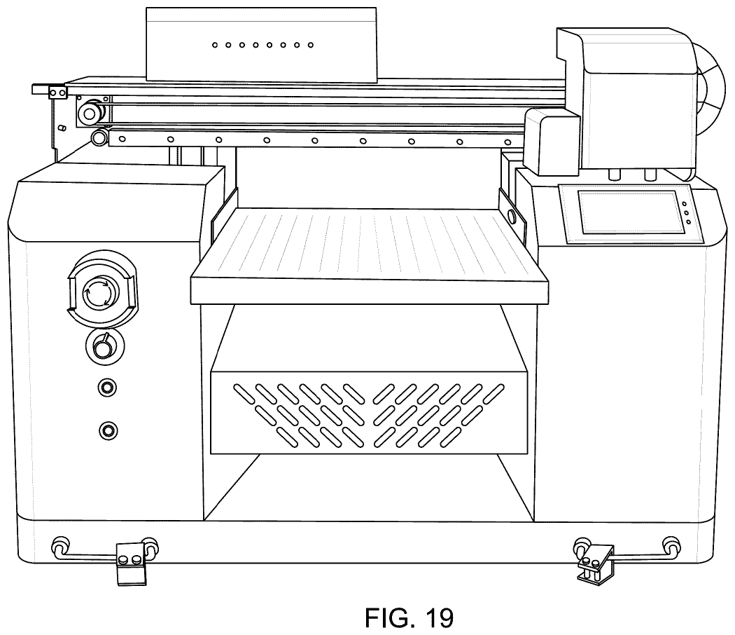

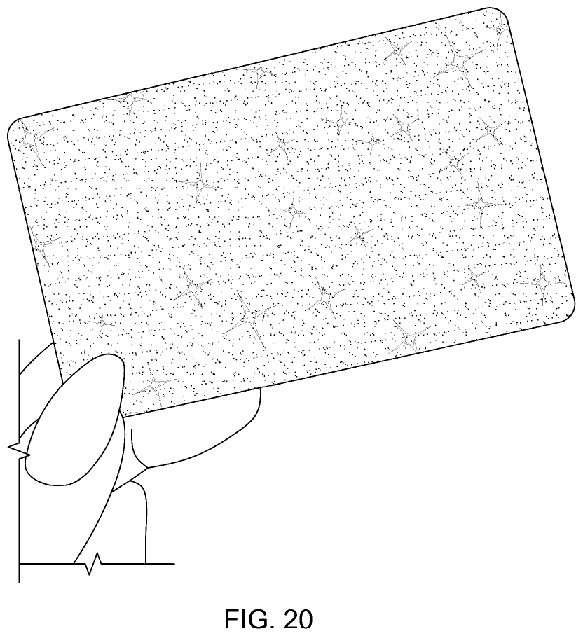

FIG. 19 shows a printing device capable of producing elements of a credit card skin overlay and/or card skin overlay with textured and decorative elements. FIG. 19 may depict a Jucolor-A3 UV printer. It is a rectangular device with a flat printing surface and a control panel featuring a touchscreen display. On the left side, there is a large red emergency stop button and a power switch below it. The right side has a white UV printing unit labeled “Jucolor” mounted above the printing bed. The entire design appears industrial in nature, intended for precision custom printing tasks.

The credit card skin overlay and/or card skin overlay may comprise multiple layers to provide the desired functionality and appearance. A wear-resistant film may form the outermost layer to protect against scratches and abrasion during normal use. Beneath this, a tiny diamond layer may provide the sparkly, textured appearance that gives the overlay its unique aesthetic. This layer may comprise reflective particles or faceted structures embedded in a transparent material to create a glittery effect.

A bottom layer may provide the main body and structure of the overlay. This layer may be composed of a cast vinyl material that is thicker than conventional credit card skins, allowing for more durability and texture. The increased thickness may allow for more three-dimensional surface features to be incorporated.

An adhesive layer may be applied to the underside of the bottom layer. This adhesive may be formulated to allow secure attachment to a credit card surface while still enabling clean removal without leaving residue. A removable release film may cover the adhesive layer prior to application, protecting it until the overlay is ready to be applied to a card.

The overlay may be manufactured through a multi-step process. The cast vinyl material may first be prepared with the desired thickness and base color. The tiny diamond layer may then be applied, potentially through techniques like embossing or embedding reflective particles. The wear-resistant film may be laminated on top. On the opposite side, the adhesive may be applied followed by the release film.

Custom designs or patterns may be printed on the overlay using UV printing techniques. A UV printer like the Jucolor-A3 model may allow for vibrant, durable printing directly onto the textured surface of the overlay. This may enable a wide range of customization options beyond just the base sparkly texture.

The overlay may be designed to fit standard credit card dimensions while accommodating features like embedded chips. Cutouts or transparent windows may be incorporated to allow visibility of important card information. The overlay may be produced in various colors and finishes to suit different aesthetic preferences.

When applied to a credit card, the overlay may transform its appearance from a plain plastic surface to a personalized, eye-catching accessory. The textured, sparkly finish may provide both visual appeal and improved grip. The durable materials may help protect the underlying card from wear and minor damage.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed:

1. A card skin overlay comprising:
a cast vinyl material;
an adhesive layer on a first side of the cast vinyl material; and
ornamental elements on a second side of the cast vinyl material.

2. The overlay of claim 1, wherein the cast vinyl material has a thickness greater than conventional credit card skins.

3. The overlay of claim 1, wherein the adhesive layer is removable.

4. The overlay of claim 1, wherein the ornamental elements comprise simulated rhinestones.

5. The overlay of claim 1, wherein the second side has a textured surface.

6. The overlay of claim 1, further comprising decorative text.

7. A method of manufacturing a card skin overlay, comprising:
preparing a cast vinyl material;
applying an adhesive layer to a first side of the cast vinyl material; and
attaching ornamental elements to a second side of the cast vinyl material.

8. The method of claim 7, wherein the cast vinyl material has a thickness similar to automotive vinyl wraps.

9. The method of claim 7, further comprising creating a textured surface on the second side.

10. The method of claim 7, further comprising incorporating decorative text into the overlay.

11. A method of customizing a card utilizing the method of claim 7, the method further comprising:
selecting a card skin overlay;
aligning the overlay with a credit card; and
pressing the overlay onto the credit card to adhere it to the card surface.

12. The method of claim 11, further comprising removing the overlay from the credit card.

13. The method of claim 12, wherein removing the overlay does not leave residue on the credit card.

14. The method of claim 11, wherein the overlay transforms the appearance of the credit card from a plain surface to a personalized object.

15. The method of claim 11, wherein the overlay changes the tactile feel of the credit card from smooth to textured.

16. A system for designing card skin overlays, comprising:
a design software interface;
a canvas area for creating overlay layouts; and
tool options for manipulating design elements.

17. The system of claim 16, further comprising the ability to open multiple design files simultaneously.

18. The system of claim 16, wherein the tool options include functions for merging, subtracting, intersecting, dividing, and cropping design elements.

19. A card skin overlay kit using the method of claim 11, the kit, comprising:
multiple overlay designs;
application instructions; and
a removal tool.

20. The kit of claim 19, wherein the multiple overlay designs include different colors, textures, and ornamental elements.
